(19) United States
(12) Patent Application Publication
(10) Pub. No.: US 2009/0241320 A1
(43) Pub. Date: Oct. 1, 2009

(54) Fasteners

(75) Inventor: Jeffrey C. Bishop, Derby (GB)

Correspondence Address: OLIFF & BERRIDGE, PLC, P.O. BOX 320850, ALEXANDRIA, VA, 22320-4850, US

(73) Assignee: ROLLS-ROYCE PLC, London (GB)

(21) Appl. No.: 12/379,678

(22) Filed: Feb. 26, 2009

(30) Foreign Application Priority Data
Mar. 26, 2008 (GB) 0805424.9

(51) Int. Cl. B23P 11/00; A44B 21/00

(52) U.S. Cl. 29/525.01; 24/456

(57) ABSTRACT

A fastener 10 for fastening a welding nozzle to a gas output device, the fastener 10 comprising: a first clamping member 12 and a second clamping member 14, moveable between an open configuration and a closed configuration, and which define an aperture 24 for receiving the welding nozzle, the first clamping member 12 including: a member 34 for resiliently engaging the welding nozzle, wherein the member 34 is arranged to be progressively deformed by the welding nozzle as the first clamping member 12 and second clamping member 14 move from the open configuration toward the closed configuration, and is arranged such that the degree of deformation of the member 34 by the welding nozzle achieved when the first and second clamping members 12, 14 reach the closed configuration is equal to, or less than, the maximum resilient deformation of the member 34.

Embodiments of the present invention relate to fasteners. In particular, they relate to fasteners for fastening a gas output device to a welding nozzle.

Welding is a process in which a welding nozzle may be used to heat and thereby melt surfaces of two separate metallic articles. When the two surfaces are liquefied they may be joined together and then allowed to cool and solidify to form a single article. When welding articles together, it is often important that the welding takes place in an inert environment in order to prevent oxidation. One way of achieving this is to use a gas output device which provides localised inert gas to the location where the articles are liquefied (often referred to as the weld puddle).

Welding nozzles usually have no obvious features which may be used for the connection of a gas output device. Consequently, the connection between the gas output device and the welding nozzle is usually improvised by the parties carrying out the weld. However, as a result such improvised connections usually result in inconsistent welds.

It is therefore desirable to provide an alternative apparatus for connecting a gas output device to a welding nozzle.

According to various embodiments of the present invention, there is provided a fastener for fastening a gas output device to a welding nozzle, the fastener comprising: a first clamping member and a second clamping member, moveable between an open configuration and a closed configuration, and which define an aperture for receiving the welding nozzle, the first clamping member including: a member for resiliently engaging the welding nozzle, wherein the member is arranged to be progressively deformed by the welding nozzle as the first clamping member and second clamping member move from the open configuration toward the closed configuration, and is arranged such that the degree of deformation of the member by the welding nozzle achieved when the first and second clamping members reach the closed configuration is equal to, or less than, the maximum resilient deformation of the member, wherein the first and second clamping members (12, 14) each include two or more resilient members (34) arranged in a plurality of different planes.

The first clamping member and the second clamping member may abut one another when they are in the closed configuration.

The member for resiliently engaging the welding nozzle may be arranged to resiliently move from a first configuration as it is deformed by the welding nozzle. The member may be resiliently biased towards the first configuration.

The member for engaging the welding nozzle may include an elongate portion which is connected to the first clamping member at an end and is arranged to be resiliently moveable about that end.

The fastener may comprise a support which is arranged to support the welding nozzle when the fastener is subject to a moment of force by being connected to a gas output device.

The fastener may comprise a releasable closing mechanism which is configured to enable a user to move the first and second clamping members between the open and closed configurations.

The fastener may be for fastening a ceramic tube of the welding nozzle to the gas output device.

The fastener may be provided with location features which apply no load in normal use of fastener but react a moment of rotational force of the tube. The location features may be arranged a plurality of different planes. Preferably the location features are in the same planes as the resilient members.

According to various embodiments of the present invention, there is provided a gas output device comprising the fastener as described in the preceding paragraphs.

According to various embodiments of the present invention, there is provided a welding apparatus comprising the fastener as described in the preceding paragraphs.

According to various embodiments of the present invention, there is provided a method of fastening a gas output device to a welding nozzle, the method comprising: providing a fastener including a first clamping member and a second clamping member, moveable between an open configuration and a closed configuration, and which define an aperture for receiving the welding nozzle, the first clamping member including a member for resiliently engaging the welding nozzle; inserting the welding nozzle in the aperture; and moving the first clamping member and the second clamping member from the open configuration toward the closed configuration, wherein the member is arranged to be progressively deformed by the welding nozzle as the first clamping member and second clamping member move from the open configuration toward the closed configuration, and is arranged such that the degree of deformation of the member by the welding nozzle achieved when the first and second clamping members reach the closed configuration is equal to, or less than, the maximum resilient deformation of the member.

For a better understanding of the present invention reference will now be made by way of example only to the accompanying drawings in which:

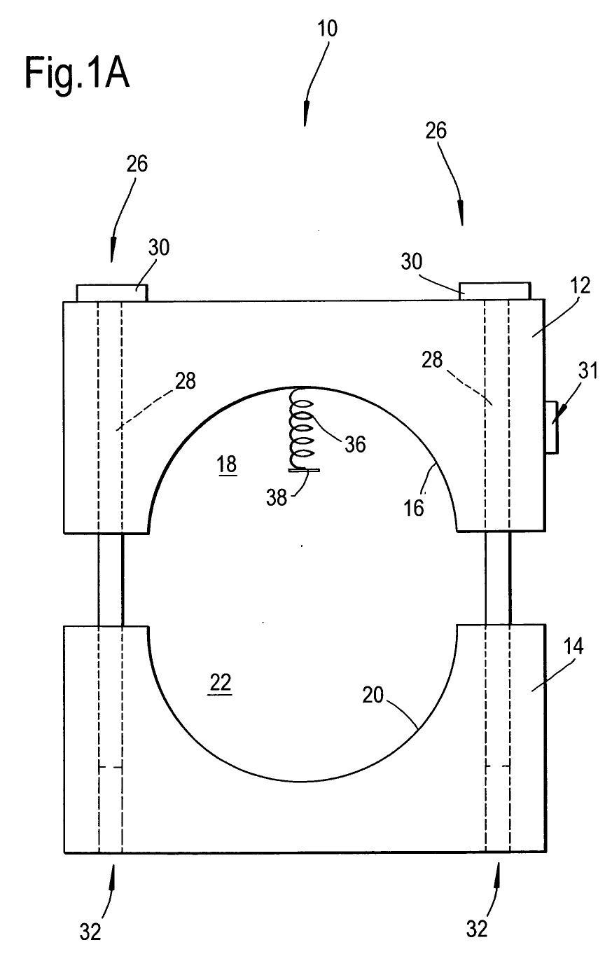

FIG. 1A illustrates a schematic plan view of a fastener in an open configuration according to one embodiment of the present invention;

FIG. 1B illustrates a schematic plan view of a fastener in a closed configuration according to one embodiment of the present invention

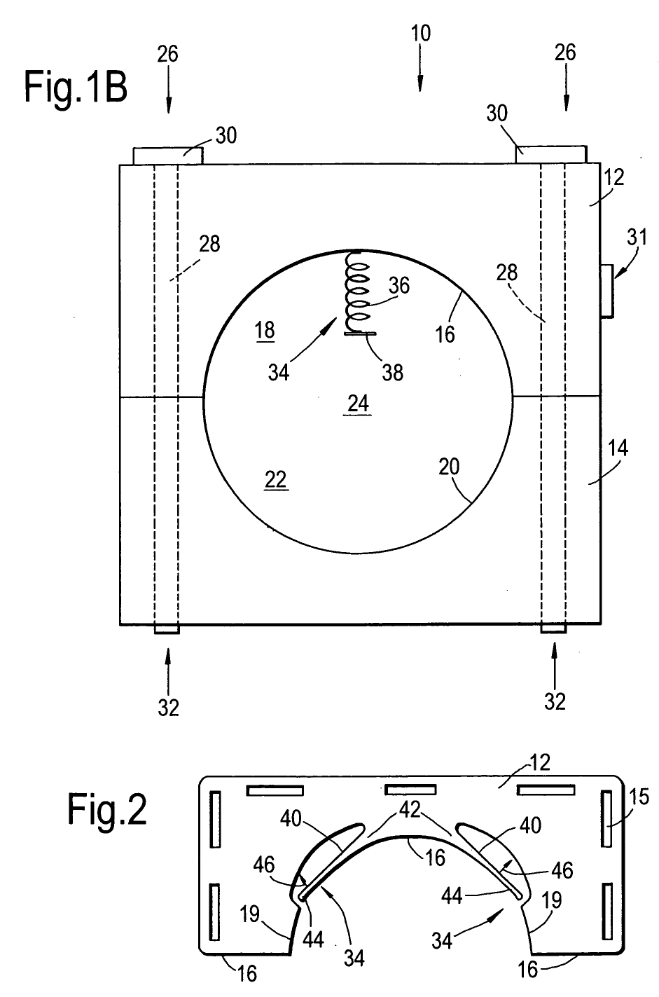

FIG. 2 depicts a clamping member according to a second aspect of the invention.

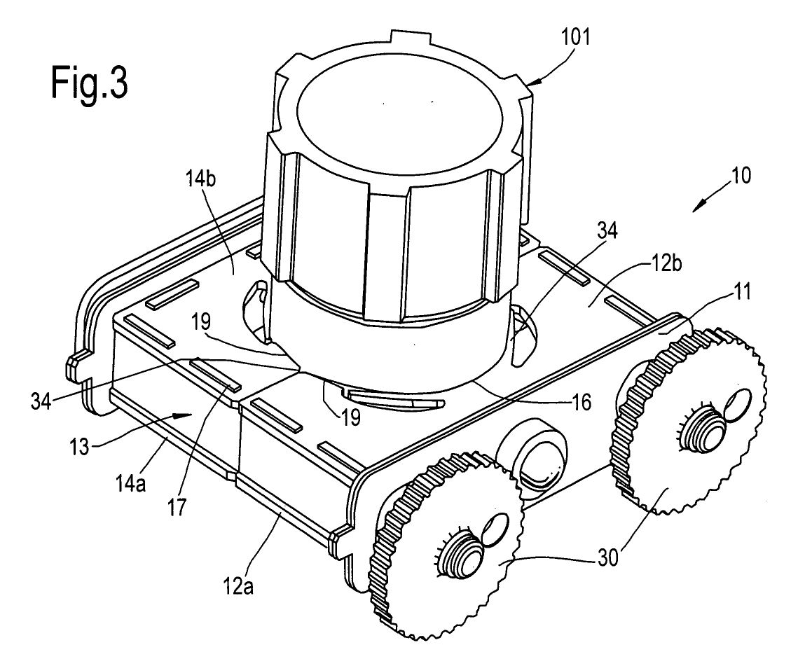

FIG. 3 is a perspective view of an assembled fastener enclosing a weld nozzle.

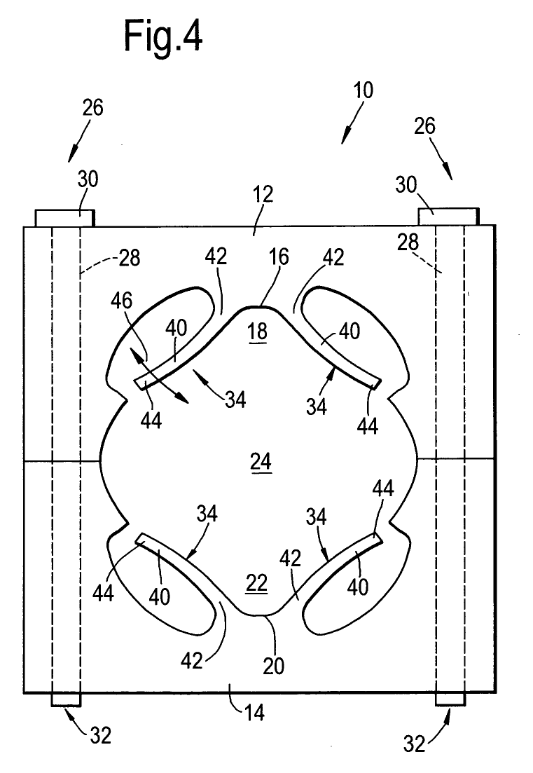

FIG. 4 illustrates a plan view of a fastener according to another embodiment of the present invention;

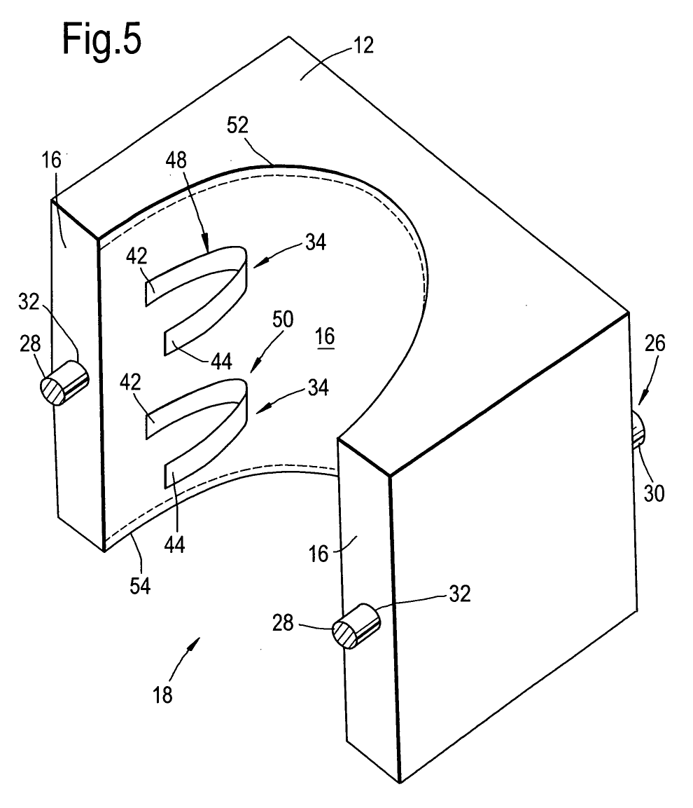

FIG. 5 illustrates a perspective view of a clamping member according to one embodiment of the present invention;

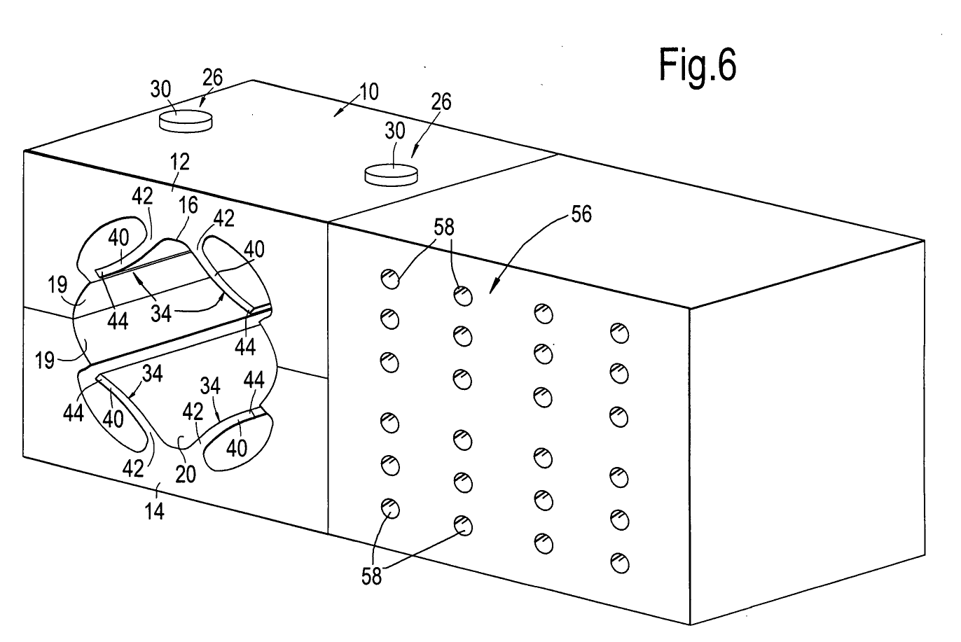

FIG. 6 illustrates a plan view of a gas output device according to one embodiment of the present invention.

FIGS. 1A, 1B, 2, 3, 4, 5 and 6 illustrate a fastener 10 for fastening a gas output device to a welding nozzle, the fastener 10 comprising: a first clamping member 12 and a second clamping member 14, moveable between an open configuration and a closed configuration, and which define an aperture 24 for receiving the welding nozzle, the first clamping member 12 including: a member 34 for resiliently engaging the welding nozzle, wherein the member 34 is arranged to be progressively deformed by the welding nozzle as the first clamping member 12 and second clamping member 14 move from the open configuration toward the closed configuration, and is arranged such that the degree of deformation of the member 34 by the welding nozzle achieved when the first and second clamping members 12, 14 reach the closed configuration is equal to, or less than, the maximum resilient deformation of the member 34.

FIGS. 1A and 1B illustrates a plan view of a fastener 10 for fastening a gas output device to a welding nozzle. The fastener 10 includes a first clamping member 12 and a second clamping member 14 which are moveable between an open configuration (as illustrated in FIG. 1A) for receiving a gas output device and a closed configuration (as illustrated in FIG. 1B) for clamping and thereby retaining the gas output device.

The first clamping member 12 is generally cuboidal in shape and includes a side 16 which defines a recess 18 which is substantially semicircular when viewed in plan. The second clamping member 14 may be seen as a ‘mirror image’ of the first clamping member 12 and is therefore also generally cuboidal in shape and includes a side 20 which defines a recess 22 which is substantially semicircular when viewed in plan.

When the first and second clamping members 12, 14 are in the open configuration (as illustrated in FIG. 1A), the sides 16, 20 are spaced apart from one another so that they do not abut one another. In this configuration, a gas output device may be inserted between the first and second clamping members 12, 14. However, when the first and second clamping members 12, 14 are in the closed configuration (as illustrated in FIG. 1B), the sides 16, 20 abut one another along a portion of their respective lengths. In this configuration, the first and second clamping members 12, 14 are configured to clamp and thereby retain a gas output device. It should be appreciated that in other embodiments, an intermediate member (such as a washer) may be provided so that when the first and second clamping members 12, 14 are in the closed configuration, the sides 16, 20 abut the intermediate member along a portion of their lengths.

In the closed configuration, the recesses 18, 22 join together so that the first and second clamping members 12, 14 define an aperture 24 through the fastener 10 which is substantially circular when viewed in plan and substantially tubular when viewed in perspective. In this embodiment, the aperture 24 is shaped and sized to receive a tubular welding nozzle but it should be appreciated that in other embodiments, the aperture 24 may be shaped and sized to receive a welding nozzle of any other shape.

The fastener 10 includes a releasable closing mechanism 26 which is configured to enable a user to move the first and second clamping members 12, 14 between the open and closed configurations. In this embodiment, the releasable closing device 26 includes two members which each include an elongate screw portion 28 and a handle 30. The elongate screw portions 28 each extend through, and engage corresponding threading on the walls of an aperture 32 in the first and second clamping members 12, 14. The handles 30 may be operated by a user to turn the elongate screw portions 28 within the apertures 32 and thereby move the first and second clamping members 12, 14 between the open and closed configurations.

The fastener 10 also includes a connector 31 for connecting the fastener 10 to a gas output device. The connector 31 may be any suitable connector and may include a screw for being received in an aperture in the gas output device. In this embodiment, the connector 31 is located on the first clamping member 12 but it should be appreciated that connectors may be located on the first clamping member 12 and/or the second clamping member 14.

The first clamping member 12 includes a member 34 for resiliently engaging a welding nozzle. In this embodiment, the member 34 includes a compression spring 36 which is connected at one end to the side 16 in the recess 18, and at the other end to a buffer 38 which is arranged to engage the welding nozzle. When no external forces act on the member 34, the compression spring 36 is in a first configuration and has a length L. The compression spring 36 is resiliently biased towards the first configuration.

In use, a user first moves the first and second clamping members 12, 14 to the open configuration by operating the releasable closing mechanism 26. When the open configuration is reached, a welding nozzle is inserted between the first and second clamping members 12, 14 so that it is positioned adjacent the recesses 18, 22. The user then operates the releasable closing mechanism 26 once again so that the first and second clamping members 12, 14 are moved toward their closed configuration, closing around the nozzle as they do so. As they are moved towards the closed configuration, the buffer 38 engages the welding nozzle and the compression spring 36 is resiliently deformed from the first configuration so that its length becomes less than the length L when in the first configuration.

The compression spring 36 is progressively further deformed by the welding nozzle as the first and second clamping members 12, 14 continue to move towards the closed configuration. It should be appreciated that as the member 34 is progressively deformed by the welding nozzle, the compression spring 36 provides a progressively increasing force against the welding nozzle that clamps it between the buffer 38 and the side 20 of the second clamping member 14. When the first and second clamping members 12, 14 reach the closed configuration, the compression spring 36 is arranged such that the degree of deformation of the spring 36 by the welding nozzle is equal to, or less than, the maximum resilient deformation of the spring 36.

When the first and second clamping members 12, 14 are in the closed configuration, the gas output device is firmly clamped between the member 34 and the side 20 and thereby retained in the aperture 24. Consequently, the user can then attach a gas output device to the fastener 10 at the connector 31 and then carry out his intended weld by using the combined gas output device and welding nozzle.

FIG. 2 illustrates a plan view of a fastener 10 according to another embodiment of the present invention. The fastener 10 illustrated in FIG. 2 is similar to the fastener 10 illustrated in FIGS. 1A and 1B and where the features are similar, the same reference numerals are used.

In FIG. 2 a clamping member 12 is shown which is used with a complementary clamping member. The clamping member has two members 34 for resiliently engaging a welding nozzle. The members 34 on the clamping member 12 each include an elongate portion 40 which is connected at a first end 42 to the side 16. Second ends 44 of the elongate portions 40 (opposite to the first end 42) are free standing and are spaced apart from the side 16.

The elongate portions 40 are arranged to move about the first end 42 in the directions indicated by arrow 46 for example. When no external forces are acting on the members 34, the elongate portions 40 are in the first configuration and are positioned such that the second ends 44 are spaced apart from the side 16 respectively. The members 34 are resiliently biased towards the first configuration. When the first clamping member 12 are moved toward the closed configuration, the elongate portions 40 engage and are deformed by the welding nozzle so that the second ends 44 are moved towards the side 16.

The members 34 are arranged so that the elongate portions 40 are progressively deformed by the welding nozzle as the clamping member 12 is moved towards the closed configuration. When the clamping member 12 reaches the closed configuration, the elongate portions 40 are arranged such that the degree of deformation of the portions 40 by the welding nozzle is equal to, or less than, the maximum resilient deformation of the portions 40 (i.e. the second ends 44 do not abut the side 16 prior to the clamping member 12 reaching its closed configuration). The force on the nozzle is therefore determined by the degree of those of the portions 40 at the closed configuration, not by how hard the screw portions 28 are tightened.

The clamp member 12 is formed of sheet metal with its form cut by a laser. The member is provided with a series of slots 15 which engage with tabs 17 (see FIG. 3) that enable the clamp member to be formed into a box-type shape.

FIG. 3 is a perspective view of the clamp in its closed arrangement clamping round a welding nozzle 101. Each clamp member 12, 14 is provided as a box having upper and lower plates 12a, 12b and 14a, 14b respectively. Each of the plates has spring members 34 so that the nozzle 101 is supported by a total of eight springs. The plates 12a, 12b are spaced by walls 13 and a rear plate 11 to enclose a volume. The face of the clamping member 12 that abuts the opposing face of the other clamping member 14 is left open.

Each plate of the clamp is provided with “close” locations 16, 19 that serve to centralise the tightened clamp around the ceramic nelding nozzle 101 without actually imparting any clamping load. The beam springs 34 provide the clamping load that secures the position of the clamp onto the ceramic nozzle 101. The maximum deformation of the springs 34 will be at the point where the opposed side plates 12a, 14a and 12b, 14b come into contact at their common interface. Any further tightening of the wheels 30 will not result in additional clamping on the ceramic.

Since each of the plates 12a, 12b, 14a, 14b are identical it will be appreciated that the ceramic is clamped in two separate and parallel planes such that the bilateral equilibrium of clamping loads is achieved across the ceramic section giving a self-centring action of the clamp around the ceramic.

The close locations 16, 19 not only serve to centralise the welding nozzle 101 but also provide a “rim” that are arranged to function as a support for the welding nozzle when the fastener 10 is subject to a moment of force by being connected to a gas output device. The rims provide an advantage in that when a gas output device provides a moment of force to the fastener 10, the rims abut the welding nozzle and provide a reaction force to counter the moment of force. Consequently, the spring members 34 are relatively unaffected by, and are substantially isolated from the moment of force provided by the gas output device and continue to provide a balanced clamping force to the welding nozzle.

In the embodiment of FIG. 4, the first and second clamping members 12, 14 each include two members 34 for resiliently engaging a welding nozzle. The members 34 on the first and second clamping members 12, 14 each include an elongate portion 40 which is connected at a first end 42 to the side 16 or 18 respectively. Second ends 44 of the elongate portions 40 (opposite to the first end 42) are free standing and are spaced apart from the sides 16 or 18 respectively.

The springs of member 12 and the springs of member 14 are of slightly different form which affects how the welding nozzle is supported.

The elongate portions 40 are arranged to move about the first end 42 in the directions indicated by arrow 46 for example. When no external forces are acting on the members 34, the elongate portions 40 are in the first configuration and are positioned such that the second ends 44 are spaced apart from the sides 16 or 20 respectively. The members 34 are resiliently biased towards the first configuration. When the first and second clamping members 12, 14 are moved toward the closed configuration, the elongate portions 40 engage and are deformed by the welding nozzle so that the second ends 44 are moved towards the sides 16 or 20 respectively.

The members 34 are arranged so that the elongate portions 40 are progressively deformed by the welding nozzle as the first and second clamping members 12, 14 are moved towards the closed configuration. When the first and second clamping members 12, 14 reach the closed configuration, the elongate portions 40 are arranged such that the degree of deformation of the portions 40 by the welding nozzle is equal to, or less than, the maximum resilient deformation of the portions 40 (i.e. the second ends 44 do not abut the sides 16 or 20 respectively prior to the first and second clamping members 12, 14 reaching the closed configuration). The force on the nozzle is therefore determined by the degree of those of the portions 40 at the closed configuration, not by how hard the screw portions 28 are tightened.

FIG. 5 illustrates a perspective view of a first clamping member 12 according to one embodiment of the present invention. The first clamping member 12 illustrated in FIG. 5 is similar to the first clamping member 12 illustrated in FIG. 4 and where the features are similar, the same reference numerals are used.

In this embodiment, the first clamping member 12 includes four members 34 for resiliently engaging a welding nozzle (only two members 34 are illustrated in FIG. 5 due to the perspective view but it should be appreciated that a further two members 34 are provided on the other leg of the member 12, in positions similar to those illustrated in FIG. 2). The members 34 can be viewed as being arranged into two pairs (member 48 is in a first pair and member 50 is in a second pair) where each pair is provided at a different position/in a different plane, along the axis of the first clamping member 12. This arrangement of the members 34 provides more stable clamping of the welding nozzle because the welding nozzle is clamped at a plurality of different positions along its axis and around its axis and is less likely to pivot about the members 34.

The first clamping member 12 includes a first rim 52 which is positioned at the top edge of the side 16 and a second rim 54 which is positioned at the bottom edge of the side 16. The rims 52 & 54 are arranged to function as a support for the welding nozzle when the fastener 10 is subject to a moment of force by being connected to a gas output device. The rims 52 & 54 provide an advantage in that when a gas output device provides a moment of force to the fastener 10, the rims 52 & 54 abut the welding nozzle and provide a reaction force to counter the moment of force. Consequently, the members 34 are relatively unaffected by, and are substantially isolated from the moment of force provided by the gas output device and continue to provide a balanced clamping force to the welding nozzle.

FIG. 6 illustrates a fastener 10 which is connected to a gas output device 56 according to one embodiment of the present invention. The fastener 10 illustrated in FIG. 6 is similar to the fastener 10 illustrated in FIG. 4, and where the features are similar, the same reference numerals are used. The gas output device 56 includes a plurality of apertures 58 through which an inert gas may be provided to a weld puddle.

In this embodiment, the gas output device 56 and the fastener 10 are an integral, unitary apparatus. However, in other embodiments, the gas output device 56 and the fastener 10 may not be integral to one another and may be attachable/detachable by a user.

Embodiments of the present invention provide several advantages. One advantage is that since the gas output device is connected to the welding nozzle, it is positioned close to the weld puddle during the welding process and does not need to be moved separately by the welder. Additionally, since the gas output device may be firmly retained on the welding nozzle at a consistent position, the resulting welds are more consistent and of higher quality.

Usually, welding nozzles comprise a ceramic tube which is relatively brittle and delicate. Embodiments of the present invention provide an advantage in that the gas output device may be coupled to the ceramic tube without causing any, or little damage to the ceramic tube. The member 34 is arranged so that it does not reach its maximum resilient deformation prior to the first and second clamping members reaching the closed configuration. Consequently, the ceramic tube is not crushed between the buffer 38 and the side 20 when the first and second clamping members 12, 14 are moved towards the closed configuration because the compression spring 36 retains the ability to be resiliently compressed at least up until when the first and second clamping members 12, 14 reach the closed configuration. The maximum force applied to the nozzle is therefore determined by the degree of compression of the spring when the clamping members are fully closed. In particular, any further tightening of the screw portions 28 will increase the clamping force between the clamping members, but not between the nozzle and the clamping members.

In addition the provision of springs axially along the length of the ceramic tube has beneficial effects on the centring of the clamp around the nozzle. The provision of clamping locations that apply no clamping loads in themselves but help to centre the nozzle also limit the angular rotation of the nozzle. This is of particular benefit where components are secured to the nozzle through the clamp and the components are of such a size or length that they generate considerable gravitational moments about a vertically orientated ceramic tube.

Although embodiments of the present invention have been described in the preceding paragraphs with reference to various examples, it should be appreciated that modifications to the examples given can be made without departing from the scope of the invention as claimed. For example, the fastener 10 may used in other applications such as for fastening a glass test tube (commonly used in laboratories) to an apparatus. Also, the member 34 for resiliently engaging a welding nozzle may have any form and shape.

1. A fastener for fastening a gas output device to a welding nozzle, the fastener comprising:
a first clamping member and a second clamping member, moveable between an open configuration and a closed configuration, and which define an aperture for receiving the welding nozzle, the first clamping member including:
a member for resiliently engaging the welding nozzle, wherein the member is arranged to be progressively deformed by the welding nozzle as the first clamping member and second clamping member move from the open configuration toward the closed configuration, and is arranged such that the degree of deformation of the member by the welding nozzle achieved when the first and second clamping members reach the closed configuration is equal to, or less than, the maximum resilient deformation of the member, wherein the first and second clamping members each include two or more resilient members arranged in a plurality of different planes.

2. A fastener as claimed in claim 1, wherein the first clamping member and the second clamping member abut one another when they are in the closed configuration.

3. A fastener as claimed in claim 1, wherein the member for resiliently engaging the welding nozzle is arranged to resiliently move from a first configuration as it is deformed by the welding nozzle, the member being resiliently biased towards the first configuration.

4. A fastener as claimed in claim 3, wherein the member for engaging the welding nozzle includes an elongate portion which is connected to the first clamping member at an end and is arranged to be resiliently moveable about that end.

5. A fastener as claimed in claim 1, comprising a support which is arranged to support the welding nozzle when the fastener is subject to a moment of force by being connected to a gas output device.

6. A fastener as claimed in claim 1, comprising a releasable closing mechanism which is configured to enable a user to move the first and second clamping members between the open and closed configurations.

7. A fastener as claimed in claim 1, wherein the fastener encloses a ceramic or glass tube the fastener further comprising location features which apply no load in normal use of fastener but react a moment of rotational force of the tube.

8. A fastener as claimed in claim 7, wherein the location features are arranged in a plurality of different planes.

9. A fastener as claimed in claim 8, wherein the location features are in the same planes as the members.

10. A welding apparatus comprising the fastener as claimed in claim 1.

11. A method of fastening a gas output device to a welding nozzle, the method comprising:
providing a fastener including a first clamping member and a second clamping member, moveable between an open configuration and a closed configuration, and which define an aperture for receiving the welding nozzle, the first clamping member including a member for resiliently engaging the welding nozzle;
inserting the welding nozzle in the aperture; and
moving the first clamping member and the second clamping member from the open configuration toward the closed configuration, wherein the member is arranged to be progressively deformed by the welding nozzle as the first clamping member and second clamping member move from the open configuration toward the closed configuration, and is arranged such that the degree of deformation of the member by the welding nozzle achieved when the first and second clamping members reach the closed configuration is equal to, or less than, the maximum resilient deformation of the member.
